(19) United States
(12) Patent Application Publication
(10) Pub. No.: US 2009/0272801 A1
(43) Pub. Date: Nov. 5, 2009

(54) DETERRING CHECKOUT FRAUD

(76) Inventors: Jonathan H. Connell, II, Cortlandt-Manor, NY (US); Myron D. Flickner, San Jose, CA (US); Norman Haas, Mount Kisco, NY (US); Arun Hampapur, Norwalk, CT (US); Sharathchandra U. Pankanti, Norwalk, CT (US); Unsang Park, East Lansing, MI (US)

Correspondence Address: HOFFMAN WARNICK LLC, 75 STATE ST, 14TH FLOOR, ALBANY, NY, 12207, US

(21) Appl. No.: 12/112,318

(22) Filed: Apr. 30, 2008

(51) Int. Cl. G06K 7/00

(52) U.S. Cl. 235/383

(57) ABSTRACT

Aspects of the present invention provide an approach for deterring checkout fraud comprising a camera (e.g., still, video, etc.) that is located near (overhead) a scanner used to scan a barcode of an item being purchased. Specifically, the barcode of the item is scanned and an image of the item is recorded. It is then determined whether the identity of the item as determined based on the barcode is consistent with its appearance as determined from the image. If not, a discrepancy is registered. It is then determined whether the discrepancy is due to fraud (e.g., theft) or device error. In the case of the latter, the system can be updated to prevent a repeat of the error. In either event, the scan, the image and a shopping event corresponding to the scan and image can be logged for future analysis and/or learning.

### CROSS-REFERENCE TO RELATED APPLICATIONS

This application is related in some aspects to the commonly owned and co-pending application entitled “Secure Checkout System,” filed Jul. 24, 2007, and which is assigned attorney docket number END920070220US1 and U.S. patent application Ser. No. 11/782,177, the entire contents of which are herein incorporated by reference. This application is related in some aspects to the commonly owned and co-pending application entitled “Smart Scanning System,” filed May 31, 2007, and which is assigned attorney docket number END920070210US1 and U.S. patent application Ser. No. 11/756,391, the entire contents of which are herein incorporated by reference. This application is also related in some aspects to the commonly owned and co-pending application entitled “Portable Device-Based Shopping Checkout,” filed May 31, 2007, and which is assigned attorney docket number END920070211US1 and U.S. patent application Ser. No. 11/756,382, the entire contents of which are herein incorporated by reference.

### FIELD OF THE INVENTION

Aspects of the present invention generally relate to deterring checkout fraud. Specifically, an embodiment of the present invention relates to a system in which a camera (e.g., still or video) captures an image of an item scanned (e.g., at checkout) and determines whether the image is consistent with an identity of the item as determined when the item is scanned.

### BACKGROUND OF THE INVENTION

Marketplace security has become a rising concern over recent years. Security and anti-theft concerns have only increased with the pervasiveness of scanners at checkout stations. It has become increasingly frequent for perpetrators to switch and/or alter barcodes so that an item can be obtained for a cheaper price. In addition, many retailers also utilize cameras to catch shop lifters.

Ticket switching refers to situations where the barcode scanned by the checker/clerk (at the point of sale/checkout) into the system is different from the actual barcode of the item. The barcode scanned may be different from the actual barcode of the item being purchased for several reasons: (i) the shopper may have tampered with the actual barcode tagged on the shopping item; (ii) the checker may be scanning a barcode (e.g., on her wrist) other than that that is tagged to the product, note that in a checkout involving a cashier, this situation may represent the classic case of “sweet hearting”, i.e., the shopper and the cashier collude to commit the ticket switching fraud; (iii) there may be multiple barcodes inadvertently attached to the shopping item; and/or the like. Note that the ticket switching can happen in both cashier-based checkout as well as self-checkout. There are no existing solutions to these problems except deterring this fraud using close human supervision which is expensive and ineffective.

In view of the foregoing, there exits a need for a solution that solves at least one of the above-referenced deficiencies in the related art.

### SUMMARY OF THE INVENTION

In general, aspects of the present invention provide an approach for deterring checkout fraud comprising a camera (e.g., still, video, etc.) that is located near (overhead) a scanner used to scan a barcode of an item being purchased. Specifically, the barcode of the item is scanned and an image of the item is recorded. It is then determined whether the identity of the item as determined based on the barcode is consistent with its appearance as determined from the image. If not, a discrepancy is registered. It is then determined whether the discrepancy is due to fraud (e.g., theft) or device error. In the case of the latter, the system can be updated to prevent a repeat of the error. In either event, the scan, the image and a shopping event corresponding to the scan and image can be logged for future analysis and/or learning.

A first aspect of the present invention provides a method for deterring checkout fraud, comprising: receiving a scan of a barcode associated with an item from a scanner at a checkout station; determining an identity of the item based on the barcode; receiving a capture of an image of the item from a camera located near the checkout station; and determining whether the identity is consistent with an appearance of the item as determined from the image.

A second aspect of the present invention provides a system for deterring checkout fraud, comprising: a module for receiving a scan of a barcode associated with an item from a scanner at a checkout station; a module for determining an identity of the item based on the barcode; a module for receiving a capture of an image of the item from a camera located near the checkout station; and a module for determining whether the identity is consistent with an appearance of the item as determined from the image.

A third aspect of the present invention provides a program product stored on a computer readable medium for deterring checkout fraud, the computer readable medium comprising program code for causing a computer system to: receive a scan of a barcode associated with an item from a scanner at a checkout station; determine an identity of the item based on the barcode; receive a capture of an image of the item from a camera located near the checkout station; and determine whether the identity is consistent with an appearance of the item as determined from the image.

A fourth aspect of the present invention provides a method for deploying a system for deterring checkout fraud, comprising: providing a computer infrastructure being operable to: receive a scan of a barcode associated with an item from a scanner at a checkout station; determine an identity of the item based on the barcode; receive a capture of an image of the item from a camera located near the checkout station; and determine whether the identity is consistent with an appearance of the item as determined from the image.

A fifth aspect of the present invention provides a data processing system for deterring checkout fraud, comprising: a memory medium having instructions; a bus coupled to the memory medium; and a processor coupled to the bus that when executing the instructions causes the data processing system to: receive a scan of a barcode associated with an item from a scanner at a checkout station; determine an identity of the item based on the barcode; receive a capture of an image of the item from a camera located near the checkout station; and determine whether the identity is consistent with an appearance of the item as determined from the image.

A seventh aspect of the present invention provides a computer-implemented business method for deterring checkout fraud, comprising: receiving a scan of a barcode associated with an item from a scanner at a checkout station; determining an identity of the item based on the barcode; receiving a capture of an image of the item from a camera located near the checkout station; and determining whether the identity is consistent with an appearance of the item as determined from the image.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative system for deterring checkout fraud according to an embodiment of the present invention.

FIG. 2 depicts an illustrative scanner according to an embodiment of the present invention.

FIG. 3 depicts an illustrative scanner according to another embodiment of the present invention.

FIG. 4 depicts a more specific computerized implementation according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

Aspects of the present invention provide an approach for deterring checkout fraud comprising a camera (e.g., still, video, etc.) that is located near (overhead) a scanner used to scan a barcode of an item being purchased. Specifically, the barcode of the item is scanned and an image of the item is recorded. It is then determined whether the identity of the item as determined based on the barcode is consistent with its appearance as determined from the image. If not, a discrepancy is registered. It is then determined whether the discrepancy is due to fraud (e.g., theft) or device error. In the case of the latter, the system can be updated to prevent a repeat of the error. In either event, the scan, the image and a shopping event corresponding to the scan and image can be logged for future analysis and/or learning.

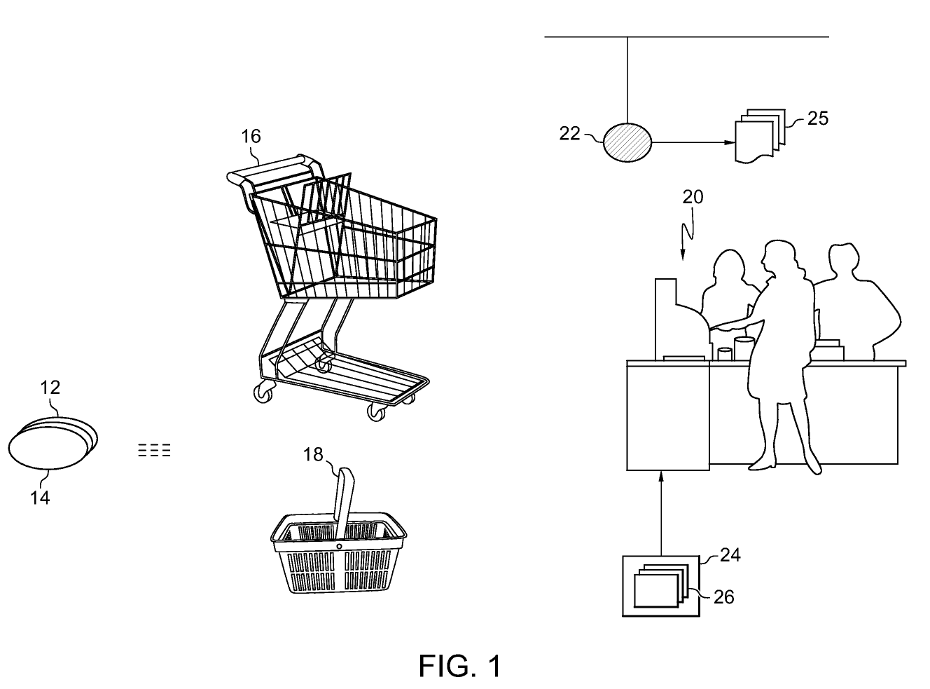

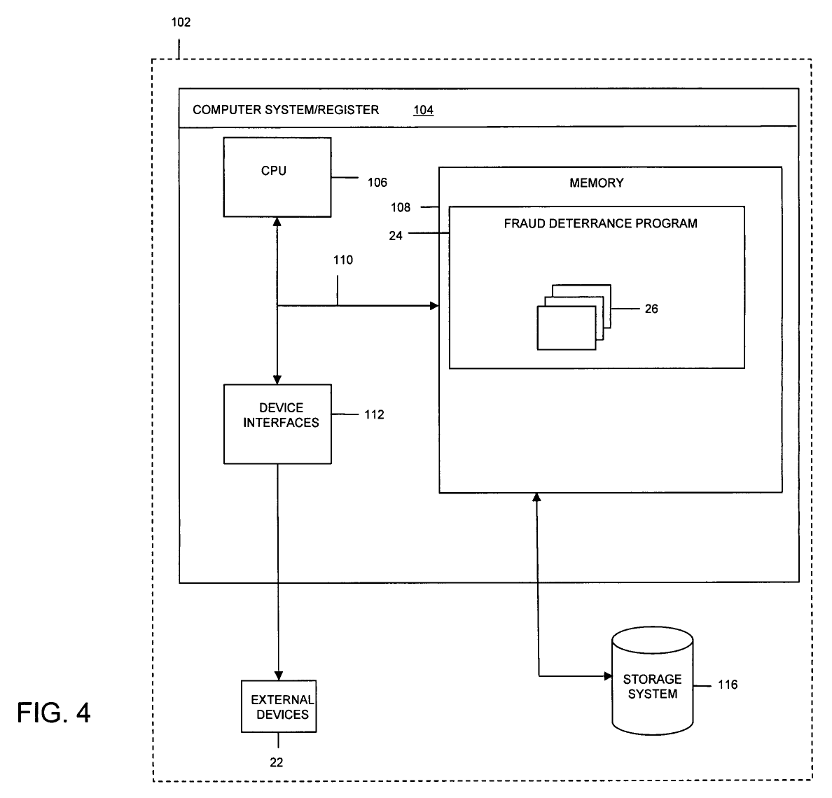

In general, the present approach has one or more of the following components (e.g., that can be provided/enabled by modules 26 of fraud deterrence program 24 discussed below in conjunction with FIGS. 1 and 4):

Capture: One or more cameras visually captures the barcode scan event at a sufficiently close range to provide either pictures or video of the process in real time.

Object Detection: By image processing methods, the portion of the image (or video frames) that includes the shopping item being purchased is automatically separated from the rest of the image.

Object Verification: Based on the visual appearance, it is confirmed (or denied) whether the expected appearance of the barcode scanned within the system is consistent (e.g., same or close) to the appearance of the item determined during the object detection phase.

Logging/Statistics: A detailed log keeps a quantitative record of the shopping item appearance, barcode, discrepancies of the expected and actual item appearances of the purchased items along with checker identity, store/lane details, and day/time/seasonal information.

Browsing/Indexing/Querying/Validation: Log of the data captured can be browsed, indexed, and queried for either post-incident investigation or real-time alerts using any solution.

Learning: Logging and statistics Logging and statistics gathering permits learning of various critical parameters for the system operation including: expected item appearance, long term baseline performance determinations and statistically significant departures from thereof.

Referring now to FIG. 1, a fraud deterrence system 10 according to an embodiment of the present invention is shown. In general, fraud deterrence system 10 comprises a checkout station 20 (e.g., a self-checkout station or an employee-based checkout station), at least one camera 22 (e.g., a still image camera, a video camera, etc.) that is located near checkout station 20, and fraud deterrence program 24 having a set (at least one) of program modules 26. Fraud deterrence program 24 can incorporate or work in conjunction with any checkout station software now known or later developed. In being located near checkout station, camera 22 can be positioned as an overhead camera (e.g., an eye in the sky), or in any location throughout the store as now known or later developed. In addition, although FIG. 1 shows one camera 22, this is for illustrative purposes only. To this extent, the present invention can be implemented using any quantity of cameras.

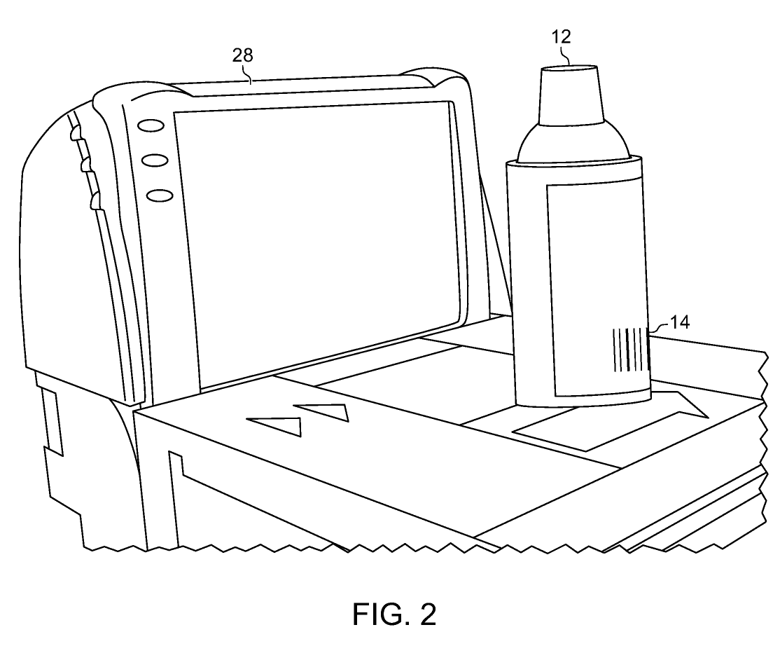

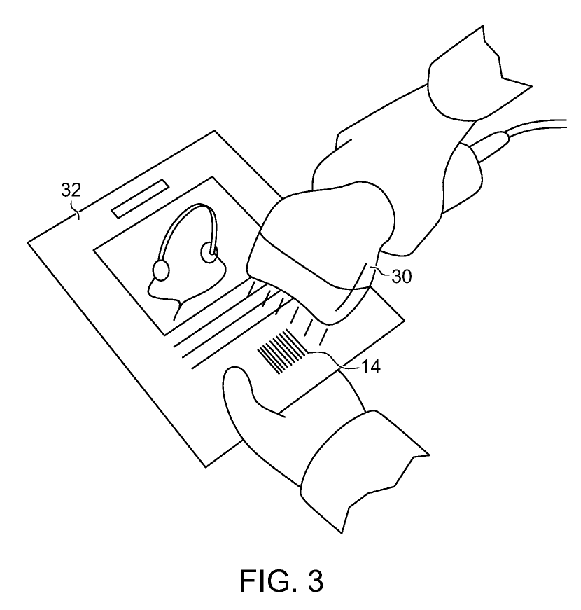

The functions of fraud deterrence system 10 will now be explained in greater detail. Specifically, as is well known, as a shopper shops, he/she may place one or more items 12 into a shopping receptacle such as a cart 16 or basket 18. When the shopper reaches a checkout station 20, the barcode 14 of items 12 will be scanned as part of the checkout process. Under the present invention, the scanning can be accomplished using any type of scanner now known or later developed. For example, the scanner could be a fixed checkout station scanner 28 as shown in FIG. 2, and/or a handheld scanner 30 as shown in FIG. 3. Handheld scanner 30 is typically used for large, heavy or “pass-around” items, or for scanning a barcode 14 separate from item 12 such as that present in an advertisement 32. Regardless, the present invention is designed to reduce or eliminate any loss that may come from label tampering or confusion. When a scan of a barcode 14 of an item 12 is received, fraud deterrence system 10 (e.g., by executing fraud deterrence program 24) will determine an identity of item 12. This occurs via known means such as cross-referencing a table of barcode values to product identities.

Before, after or simultaneous to the scan of a barcode, a set (e.g., one or more) of images 25 of the corresponding item 12 will be captured by camera 22, and processed to determine an appearance of the item 12 (which should be consistent with the identity as determined based on the scan of barcode 14). The sequence of capturing and processing the image is typically as follows: wait for low motion of item 12; take dark and bright images 25; segment item 12 from its background; extract at least one visual feature of item 12 and determine the identity based on those visual features. This determination can be based on a comparison of the image to an electronic database or library of images associated with corresponding item identities. In addition, the appearance can be as general or as specific as desired. For example, the appearance can be specific so as to identify the item (e.g., a bottle of X brand cola), or it can be more general (e.g., a bottle of cola, or just cola based on the color).

In an illustrated embodiment, camera 22 is linked with a system executing fraud deterrence program 24. Thus, the image(s) will be received by the system on the modules 26 of fraud deterrence program 24 will compare the identity of item 12 as determined based on the scan of barcode 14 to the appearance as determined based on the image to determine if the two are consistent with one another. If not, the fraud deterrence program 24 will register a discrepancy and provide a notification of the discrepancy (at least one of a visual notification or an audible notification). Where there is a discrepancy, the fraud deterrence system 10 can determine whether the discrepancy is either error or fraud. For example, was the barcode tampered with or changed, or was the discrepancy due to device error. Where device error caused the discrepancy, the fraud deterrence system can be updated (e.g., in response to an operator's input) to reflect the true identity of the item and its association with the image just captured. Regardless, the scan, the image, and a shopping event to which they correspond/pertain can be stored for post investigation.

### II. Computerized Implementation

Referring now to FIG. 4, a computerized implementation 100 of an embodiment of the present invention is shown. As depicted, implementation 100 includes computer system/register 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, computer system/register 104 includes a processing unit 106, a memory 108, a bus 110, and device interfaces 112. Further, computer system/register 104 is shown including external devices 22 and storage system 116 that communicate with bus 110 via device interfaces 112. In general, processing unit 106 executes computer program code, such as fraud deterrence program 24, which are stored in memory 108 and/or storage system 116. While executing computer program code, processing unit 106 can read and/or write data to/from memory 108, storage system 116, and/or device interfaces 112. Bus 110 provides a communication link between each of the components in computer system/register 104. Although not shown, computer system/register 104 could also include I/O interfaces that communicate with: one or more external devices such as a cash register, a scanner, a keyboard, a pointing device, a display, etc.; one or more devices that enable a user to interact with computer system/register 104; and/or any devices (e.g., network card, modem, etc.) that enable computer system/register 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computer system/register 104 is only representative of various possible computer systems that can include numerous combinations of hardware. To this extent, in other embodiments, computer system/register 104 can comprise any specific purpose computing article of manufacture comprising hardware with or without computer program code, for performing specific functions, any computing article of manufacture that comprises a combination of specific purpose and general purpose hardware/software, or the like. In each case, the program code (if included) and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external devices 114. Still further, it is understood that one or more additional components (e.g., system software, math co-processing unit, etc.) not shown in FIG. 4 can be included in computer system/register 104.

Storage system 116 can be any type of system capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system/register 104.

Shown in memory 108 of computer system/register 104 is fraud deterrence program 24, which includes a set (at least one) of modules 26. The modules generally enable computer infrastructure 102 to provide the functions of the present invention as described herein. For example (among other things), set of modules 26 is configured to: receive a scan of a barcode associated with an item from a scanner at a checkout station; determine an identity of the item based on the barcode; receive a capture of an image of the item via a camera located near the checkout station; process the image (e.g., segment from background, extract visual feature(s), etc.); determine whether the identity is consistent with an appearance of the item as determined from the image; register a discrepancy if the identity is inconsistent with the appearance; determine whether the discrepancy is either an error or fraud; determine a true identity of the item if the identity is inconsistent with the appearance to determine whether the discrepancy is either error or fraud; update computer system/register 104 to prevent an error from being repeated; provide a notification of the discrepancy, the notification being at least one of a visual notification and an audible notification; and store the scan, the image, and a shopping event pertaining thereto for post investigation.

While shown and described herein as a fraud deterrence system, method, and program item, it is understood that the invention further provides various alternative embodiments. For example, in one embodiment, the invention provides a computer-readable/useable medium that includes computer program code to enable a computer infrastructure to provide fraud deterrence. To this extent, the computer-readable/useable medium includes program code that implements one or more of the various processes described herein. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 4) and/or storage system 116 (FIG. 4) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to provide fraud deterrence. In this case, the service provider can create, maintain, and support, etc., a computer infrastructure, such as computer infrastructure 102 (FIG. 4) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a method of generating a system a computer-implemented method for fraud deterrence. In this case, a computer infrastructure, such as computer infrastructure 102 (FIG. 4), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system/register 104 (FIG. 4), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or processing device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for deterring checkout fraud, comprising:
receiving a scan of a barcode associated with an item from a scanner at a checkout station;
determining an identity of the item based on the barcode;
receiving a capture of an image of the item from a camera located near the checkout station; and
determining whether the identity is consistent with an appearance of the item as determined from the image.

2. The method of claim 1, further comprising:
registering a discrepancy if the identity is inconsistent with the appearance; and
providing a notification of the discrepancy, the notification being at least one of a visual notification or an audible notification.

3. The method of claim 2, further comprising determining a true identity of the item if the identity is inconsistent with the appearance to determine whether the discrepancy is either error or fraud.

4. The method of claim 1, the scan being received and the image being captured pursuant to a shopping event, and the method further comprising storing the scan, the image, and the shopping event.

5. The method of claim 1, the camera being one of a still camera or a video camera.

6. The method of claim 1, further comprising:
segmenting the image from a background; and
extracting at least one visual feature of the item to determine the appearance.

7. A system for deterring checkout fraud, comprising:
a module for receiving a scan of a barcode associated with an item from a scanner at a checkout station;
a module for determining an identity of the item based on the barcode;
a module for receiving a capture of an image of the item from a camera located near the checkout station; and
a module for determining whether the identity is consistent with an appearance of the item as determined from the image.

8. The system of claim 7, further comprising:
a module for registering a discrepancy if the identity is inconsistent with the appearance; and
a module for providing a notification of the discrepancy, the notification being at least one of a visual notification or an audible notification.

9. The system of claim 8, further comprising a module for determining a true identity of the item when the identity is inconsistent with the appearance to determine whether the discrepancy is either error or fraud.

10. The system of claim 7, the scan being received and the image being captured pursuant to a shopping event, and the system further comprising storing the scan, the image, and the shopping event.

11. The system of claim 7, the camera being one of a still camera or a video camera.

12. The system of claim 7, further comprising:
a module for segmenting the image from a background; and
a module for extracting at least one visual feature of the item to determine the appearance.

13. A program product stored on a computer readable medium for deterring checkout fraud, the computer readable medium comprising program code for causing a computer system to:
receive a scan of a barcode associated with an item from a scanner at a checkout station;
determine an identity of the item based on the barcode;
receive a capture of an image of the item via a camera located near the checkout station; and
determine whether the identity is consistent with an appearance of the item as determined from the image.

14. The program product of claim 13, the computer readable medium further comprising program code for causing the computer system to:
register a discrepancy if the identity is inconsistent with the appearance; and
provide a notification of the discrepancy, the notification being at least one of a visual notification or an audible notification.

15. The program product of claim 14, the computer readable medium further comprising program code for causing the computer system to determine a true identity of the item when the identity is inconsistent with the appearance to determine whether the discrepancy is either error or fraud.

16. The program product of claim 13, the scan being received and the image being captured pursuant to a shopping event, and the computer readable medium further comprising program code for causing the computer system to store the scan, the image, and the shopping event.

17. The program product of claim 13, the camera being selected from a group consisting of a still image camera and a video camera.

18. The program product of claim 13, the computer readable medium further comprising program code for causing the computer system to:
segment the image from a background; and
extract at least one visual feature of the item to determine the appearance.

19. A method for deploying a system for deterring checkout fraud, comprising:
providing a computer infrastructure being operable to:
receive a scan of a barcode associated with an item from a scanner at a checkout station;
determine an identity of the item based on the barcode;
receive a capture of an image of the item from a camera located near the checkout station; and
determine whether the identity is consistent with an appearance of the item as determined from the image.

20. The method of claim 19, the scan being received and the image being captured pursuant to a shopping event, and the computer infrastructure further being operable to store the scan, the image, and the shopping event.
